(19) United States
(12) Patent Application Publication
(10) Pub. No.: US 2011/0097455 A1
(43) Pub. Date: Apr. 28, 2011

(54) SYSTEM AND METHOD TO MIX, HOMOGENIZE, AND EMULSIFY A FLUID USING SONICATION

(75) Inventors: Jeanne L. Cate, Superior, CO (US); Kirby Dale Hayes, Evergreen, CO (US); Tricia A. Brannigan, Louisville, CO (US); Steven Lim, Longmont, CO (US)

(73) Assignee: WhiteWave Services, Inc., Dallas, TX (US)

(21) Appl. No.: 12/908,572

(22) Filed: Oct. 20, 2010

Related U.S. Application Data
(60) Provisional application No. 61/254,065, filed on Oct. 22, 2009.

(51) Int. Cl. A23L 1/025; A01J 11/16; A23C 3/02

(52) U.S. Cl. 426/238; 99/452; 99/453

(57) ABSTRACT

According to one embodiment, a method receives a fluid comprising one or more ingredients. The method selects sonication settings to apply to the fluid to yield a desired result. The sonication settings include a frequency, a power, and a duration. The method applies sonication to the fluid according to the selected sonication settings.

### RELATED APPLICATIONS

This application claims priority to U.S. Provisional Application No. 61/254,065 entitled “System and Method to Mix, Homogenize, and Emulsify a Fluid using Sonication,” filed Oct. 22, 2009.

### TECHNICAL FIELD

This invention relates generally to the field of food processing and more specifically to system and method to mix, homogenize, and emulsify a fluid using sonication.

### BACKGROUND

A fluid, such as milk or a non-dairy creamer, may be made up of particles of varying size. Over time, the larger particles may tend to separate from the smaller particles, which may cause the fluid to become non-uniform. To prevent the particles from separating, homogenization may be used to break up larger particles until they are small enough to be dispersed evenly throughout the fluid. For example, known homogenization methods may force the fluid through a restricted orifice at a high pressure to shear the particles.

### SUMMARY OF THE DISCLOSURE

According to one embodiment, a method receives a fluid comprising one or more ingredients. The method selects sonication settings to apply to the fluid to yield a desired result. The sonication settings include a frequency, a power, and a duration. The method applies sonication to the fluid according to the selected sonication settings.

Certain embodiments of the invention may provide one or more technical advantages. As an example, in some embodiments the amount of energy required to homogenize a fluid may be reduced as compared to known homogenization methods. As another example, in some embodiments a stable emulsion may be formed without emulsifiers or with fewer emulsifiers than emulsions formed using known homogenization methods. In some embodiments, costs of production may be reduced.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a system for mixing, homogenizing, and emulsifying a fluid using sonication;

FIG. 2 illustrates an example of a method for mixing, homogenizing, and emulsifying a fluid using sonication; and

FIG. 3 illustrates an example of an alternative embodiment of a method for mixing, homogenizing, and emulsifying a fluid using sonication.

### DETAILED DESCRIPTION OF THE DRAWINGS

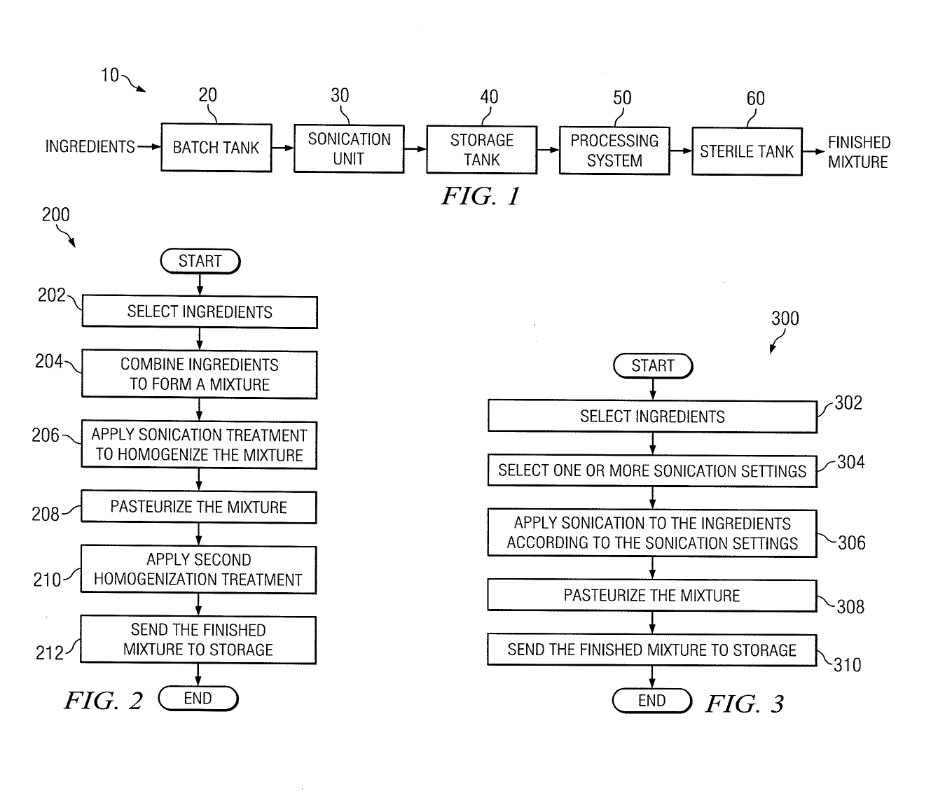

Embodiments of the present invention and its advantages are best understood by referring to FIGS. 1-3 of the drawings, like numerals being used for like and corresponding parts of the various drawings.

A fluid, such as milk or a non-dairy creamer, may be made up of particles of varying size. Over time, the larger particles may tend to separate from the smaller particles, which may cause the fluid to become non-uniform. To prevent the particles from separating, homogenization may be used to break up larger particles until they are small enough to be dispersed evenly throughout the fluid. For example, known homogenization methods may force the fluid through a restricted orifice at a high pressure to shear the larger particles.

Known methods for homogenizing a non-dairy creamer may require several iterations of high pressure homogenization. Such homogenization methods may require a high energy input and may increase production costs. Embodiments of the present disclosure may address these and other problems. For example, in some embodiments, energy requirements may be reduced by using sonication to mix, homogenize, and emulsify a fluid.

FIG. 1 illustrates an example of a system 10 for mixing, homogenizing, and emulsifying a fluid using sonication. In some embodiments, system 10 may comprise a batch tank 20, a sonication unit 30, a storage tank 40, a processing system 50, and a sterile tank 60.

In some embodiments, the batch tank 20 may receive one or more ingredients and may combine the ingredients together to form a fluid mixture. The ingredients may vary depending on the desired finished product. For example, the ingredients may be selected to yield dairy milks, non-dairy milks (e.g., soy milk, rice milk, nut milk), dairy creamers, non-dairy creamers (e.g., fat or oil based creamers), or a combination of the preceding. As an example, ingredients selected to yield a non-dairy creamer may include liquid ingredients, dry ingredients, and water. Examples of liquid ingredients may include fats and/or oils, such as palm oil, sweeteners, such as liquid sucrose and/or corn syrup, and liquid flavors. Examples of dry ingredients may include emulsifiers, stabilizers, and salts, such as monopotassium phosphate. After the ingredients have been combined, the mixture may be directed to the sonication unit 30.

In some embodiments, the sonication unit 30 may receive the mixture in a static batch or, alternatively, in a continuous flow. The mixture may be heated or unheated when received by the sonication unit 30, and the temperature of the mixture may be in the range of 35 to 165 degrees Fahrenheit, such as 130 degrees Fahrenheit. In some embodiments, the sonication unit 30 may apply ultrasound treatment, such as power ultrasound or high intensity ultrasound, to reduce the average particle size of the mixture in order to yield a desired particle size. Sonication settings may include an amplitude, a frequency, a power, and/or a duration, and may be selected to yield a desired result. For example, different settings may be used to achieve mixing, homogenizing, emulsifying, pasteurizing, or a combination of the preceding. The energy requirements may vary based on the selected result, with mixing requiring relatively lower energy and pasteurizing requiring relatively higher energy.

In some embodiments, the settings may be selected to yield an average particle size of less than one micron, such as less than 0.8 microns, using a relatively low amount of energy as compared to 2-stage high pressure homogenization. For example, the amplitude may be in the range of 0.5 to 150 microns, the frequency may be in the range of approximately 10 to 40 kHz, the power may be in the range of approximately 0.5 to 50 kW, and the duration may be in the range of approximately 0.01 to 30 minutes. Sonication settings may be optimized for a particular combination of ingredients based on factors such as the temperature, pressure, viscosity of the mixture, and/or the emulsification system used. Additionally, the settings may be affected by the back pressure at which the sonication unit 30 receives the mixture. A higher pressure may increase the intensity of the cavitation phenomenon.

Upon completion of sonication, the mixture may be directed to the storage tank 40. From storage tank 40, the mixture may be directed to the processing system 50, which may include a pasteurization system, a homogenizer, and/or other suitable elements for processing the mixture into a finished mixture. Examples of pasteurization systems include a high temperature/short time (HTST) system, an extended shelf life (ESL) system, an ultra-high temperature (UHT) system, a higher heat/shorter time (HHST) system, or a “bulk” or “batch” pasteurization system. As an example, in some embodiments, a UHT pasteurization unit may heat the mixture to a temperature of at least approximately 275 degrees Fahrenheit. The mixture may be held at the UHT temperature for enough time to achieve pasteurization, such as 1 to 2 seconds.

The processing system may or may not include a homogenizer. For example, in some embodiments, the mixture may possess suitable homogenization and emulsification properties upon exiting the sonication unit that additional homogenization may not be required. If additional homogenization treatment is desired, the mixture may be cooled and may be directed to any suitable homogenizer. For example, a sonication unit or a 2-stage high pressure homogenizer, such as a homogenizer configured for 2000/600 psi homogenization, may be used for the additional homogenization treatment.

The finished mixture (e.g., the homogenized and emulsified fluid) may be directed to the sterile tank 60. In some embodiments, sterile tank 60 may be a source that feeds fillers configured to deposit an amount of the mixture into one or more bottles, jars, cans, cartons, and/or any other appropriate container.

Modifications, additions, or omissions may be made to system 10 without departing from the scope of the invention. The components of system 10 may be integrated or separated. Moreover, the operations of system 10 may be performed by more, fewer, or other components.

FIG. 2 illustrates an example of a method 200 for mixing, homogenizing, and emulsifying a fluid using sonication. The method may begin at step 202 where one or more ingredients may be selected. The selection may vary depending on the desired finished product. For example, the ingredients may be selected to yield dairy milks, non-dairy milks (e.g., soy milk, rice milk, nut milk), dairy creamers, non-dairy creamers (e.g., fat or oil based creamers), or a combination of the preceding. As an example, ingredients selected to yield a non-dairy creamer may include liquid ingredients, dry ingredients, and water. Examples of liquid ingredients may include fats and/or oils, such as palm oil, sweeteners, such as liquid sucrose and/or corn syrup, and liquid flavors. Examples of dry ingredients may include emulsifiers, stabilizers, and salts, such as monopotassium phosphate.

At step 204, the selected ingredients may be combined to form a fluid mixture. For example, the ingredients may be combined in a batch tank. In some embodiments, the batch tank may include one or more means for blending, mixing, combining, stirring, and/or agitating the ingredients. For example, the batch tank may include mechanical agitators, pressure jets, or other suitable mixing devices, whether located within or external to the batch tank. In some embodiments, the mixture may be mixed at sonication step 206, and the ingredients may be combined at step 204 without mixing.

The mixture may be subjected to sonication treatment at step 206. In some embodiments, the sonication treatment may be configured to homogenize and/or emulsify the mixture. Sonication settings may include an amplitude, a frequency, a power, and/or a duration, and may be selected to yield a desired result, such as mixing, homogenizing, and/or emulsifying the mixture. In some embodiments, the settings may be selected to yield an average particle size of less than one micron, such as less than 0.8 microns, using a relatively low amount of energy. For example, the amplitude may be in the range of approximately 0.5 to 150 microns, the frequency may be in the range of approximately 10 to 40 kHz, the power may be in the range of approximately 0.5 to 50 kW, and the duration may be in the range of approximately 0.01 to 30 minutes. Sonication settings may be optimized for a particular combination of ingredients based on factors such as the temperature, pressure, viscosity of the mixture, and/or the emulsification system used.

At step 208, the mixture may be pasteurized. In some embodiments, the mixture may be cooled and temporarily stored prior to pasteurization. Any suitable pasteurization method may be used, for example, the mixture may be heated to a UHT pasteurization temperature of at least approximately 275 degrees Fahrenheit and held at the UHT temperature for a suitable amount of time, such as 1 to 2 seconds. In some embodiments, the mixture may be the cooled after the pasteurization.

A second homogenization treatment may be applied to the mixture at step 210. The second homogenization treatment may comprise any suitable method, such as high pressure homogenization at, for example, 2000/600 psi, or sonication treatment. In some embodiments, the mixture may possess suitable homogenization and/or emulsification properties upon completion of sonication step 206, and the second homogenization treatment of step 210 may be bypassed.

At step 212, the finished mixture may be sent to storage. The stored mixture may be a source that feeds fillers configured to deposit an amount of the mixture into one or more bottles, jars, cans, cartons, and/or any other appropriate container. The method ends upon completion of step 212.

Modifications, additions, or omissions may be made to method 200 without departing from the scope of the invention. The steps of method 200 may be performed in any suitable order. Moreover, the operations of method 200 may be performed by more, fewer, or other steps.

FIG. 3 illustrates an example of an alternative embodiment of a method 300 for mixing, homogenizing, and emulsifying a fluid using sonication. The method may begin at step 302 where ingredients may be selected. The ingredient selection step may be similar to step 202 of FIG. 2.

At step 304, one or more sonication settings may be selected. Sonication settings may include an amplitude, a frequency, a power, and a duration, and may be selected to yield a desired result. For example, different settings may be used to achieve mixing, homogenizing, emulsifying, pasteurizing, or a combination of the preceding. Additionally, external factors, such as temperature, pressure, viscosity of the mixture, emulsification system used, and/or back pressure into the sonication unit may affect the selection. In some embodiments, the amplitude may be in the range of approximately 0.5 to 150 microns, the frequency may be in the range of approximately 10 to 40 kHz, the power may be in the range of approximately 0.5 to 50 kW, and the duration may be in the range of approximately 0.01 to 30 minutes.

Sonication may be applied to the ingredients according to the sonication settings at step 306. The sonication treatment may be applied to yield a desired result, such as mixing, homogenizing, and emulsifying.

At step 308, the mixture may be pasteurized using any suitable method. The mixture may be sent to storage at step 310, where it may be a source that feeds fillers configured to deposit an amount of the mixture into one or more bottles, jars, cans, cartons, and/or any other appropriate container. The method ends upon completion of step 310.

Modifications, additions, or omissions may be made to method 300 without departing from the scope of the invention. The steps of method 300 may be performed in any suitable order. Moreover, the operations of method 300 may be performed by more, fewer, or other steps.

Certain embodiments of the invention may provide one or more technical advantages. A technical advantage of one embodiment may be that the amount of energy required to homogenize and/or emulsify a fluid may be reduced as compared to known systems. Additionally, certain embodiments may generate a stable emulsion without emulsifiers or with fewer emulsifiers than emulsions formed using known homogenization methods. In some embodiments, an emulsion may be stable when components, such as fat globules, are distributed relatively uniformly throughout the suspension with minimal tendency to separate from the suspension base over time. Decreasing the amount of emulsifiers required may reduce the costs of producing an emulsion while still maintaining a suitable shelf life. In some embodiments, the sonication treatment may improve qualitative properties of the fluid, such as texture and mouthfeel.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method, comprising:
receiving a fluid comprising one or more ingredients;
selecting sonication settings to apply to the fluid, the sonication settings selected to yield a desired result, the sonication settings including a frequency, a power, and a duration; and
applying sonication to the fluid according to the selected sonication settings.

2. The method of claim 1, wherein the fluid comprises a dairy milk, a non-dairy milk, a dairy creamer, or a non-dairy creamer.

3. The method of claim 1, the fluid substantially free of added emulsifiers.

4. The method of claim 1, wherein the desired result includes mixing, emulsifying, homogenizing, or pasteurizing the fluid.

5. The method of claim 1, wherein:
the desired result includes homogenizing the fluid; and
the sonication settings selected to yield a homogenized particle size less than one micron using less energy than required by a two-stage homogenizer configured to yield the homogenized particle size less than one micron.

6. The method of claim 1, wherein:
the frequency in the range of approximately 10 to 40 kHz;
the power in the range of approximately 0.5 to 50 kW; and
the duration in the range of approximately 0.01 to 30 minutes.

7. The method of claim 1, the sonication settings further comprising an amplitude in the range of approximately 0.5 to 150 microns.

8. The method of claim 1, further comprising heating the fluid to a pasteurization temperature and holding the fluid at the pasteurization temperature for a time period selected to pasteurize the fluid.

9. The method of claim 1, further comprising heating the fluid to a temperature in the range of 35 to 165 degrees Fahrenheit prior to applying the sonication.

10. The method of claim 1, further comprising:
determining one or more external factors, at least one of the external factors comprising a temperature of the fluid, a viscosity of the fluid, or a pressure at which the fluid is received; and
adjusting the sonication settings according to the external factors.

11. A system, comprising:
a sonication unit operable to:
receive a fluid comprising one or more ingredients;
apply sonication to the fluid according to sonication settings selected to yield a desired result, the sonication settings including a frequency, a power, and a duration.

12. The system of claim 11, wherein the fluid comprises a dairy milk, a non-dairy milk, a dairy creamer, or a non-dairy creamer.

13. The system of claim 11, the fluid substantially free of added emulsifiers.

14. The system of claim 11, wherein the desired result includes mixing, emulsifying, homogenizing, or pasteurizing the fluid.

15. The system of claim 11, wherein:
the desired result includes homogenizing the fluid; and
the sonication settings selected to yield a homogenized particle size less than one micron using less energy than required by a two-stage homogenizer configured to yield the homogenized particle size less than one micron.

16. The system of claim 11, wherein:
the frequency in the range of approximately 10 to 40 kHz;
the power in the range of approximately 0.5 to 50 kW; and
the duration in the range of approximately 0.01 to 30 minutes.

17. The system of claim 11, the sonication settings further comprising an amplitude in the range of approximately 0.5 to 150 microns.

18. The system of claim 11, further comprising a pasteurization unit operable to heat the fluid to a pasteurization temperature and hold the fluid at the pasteurization temperature for a time period selected to pasteurize the fluid.

19. The system of claim 11, further comprising a heating unit operable to heat the fluid to a temperature in the range of 35 to 165 degrees Fahrenheit prior to applying the sonication.

20. The system of claim 11, further comprising a homogenization unit operable to homogenize the fluid.
